(19) United States
(12) Patent Application Publication
(10) Pub. No.: US 2022/0185021 A1
(43) Pub. Date: Jun. 16, 2022

(54) TIRE

(71) Applicant: Sumitomo Rubber Industries, Ltd., Hyogo (JP)

(72) Inventor: Kazuhiro NAKANO, Kobe-shi (JP)

(73) Assignee: Sumitomo Rubber Industries, Ltd., Hyogo (JP)

(21) Appl. No.: 17/517,180

(22) Filed: Nov. 2, 2021

(30) Foreign Application Priority Data
Dec. 16, 2020 (JP) 2020-208703

(51) Int. Cl. B60C 11/03

(52) U.S. Cl. CPC B60C 11/0302; B60C 11/0304; B60C 2011/0353; B60C 11/033; B60C 11/0306

(57) ABSTRACT

A tire includes a tread portion including an outside tread edge located outwardly of a vehicle when being mounted to the vehicle, an inside tread edge located inwardly of a vehicle when being mounted to the vehicle, circumferential grooves extending continuously in the tire circumferential direction, and lateral grooves. The circumferential grooves includes an outside shoulder circumferential groove, an outside crown circumferential groove, an inside crown circumferential groove and an inside shoulder circumferential groove which are arranged in this order from the outside tread edge side to the inside tread edge side, and a groove width W1 of the outside shoulder circumferential groove, a groove width W2 of the outside crown circumferential groove, a groove width W3 of the inside crown circumferential groove and a groove width W4 of the inside shoulder circumferential groove satisfy the following relation: W1<W2<W3<W4.

### RELATED APPLICATIONS

This application claims the benefit of foreign priority to Japanese Patent Application No. JP2020-208703, filed Dec. 16, 2020, which is incorporated by reference in its entirety.

### FIELD OF THE INVENTION

The present disclosure relates to a tire.

### BACKGROUND OF THE INVENTION

The following Patent Document 1 discloses a pneumatic tire. The tire includes a tread portion which is provided with center main grooves extending continuously in the tire circumferential direction on the tire equator side and shoulder main grooves extending continuously in the tire circumferential direction located on the tread edge sides with respect to the center grooves.

### [Patent Document]

[Patent document 1] Japanese Unexamined Patent Application Publication 2012-224245

### SUMMARY OF THE INVENTION

In recent years, consideration for the living environment has been emphasized, and reduction of pattern noise of tires is desired. In addition, sufficient traction of tires is also required on snowy roads.

The present disclosure has been made in view of the above circumstance and has a major object to provide a tire capable of reducing pattern noise while maintaining traction on snow.

In one aspect of the present disclosure, a tire includes a tread portion having a designated mounting direction to a vehicle, the tread portion including an outside tread edge located outwardly of a vehicle when being mounted to the vehicle, an inside tread edge located inwardly of a vehicle when being mounted to the vehicle, a plurality of circumferential grooves extending continuously in a tire circumferential direction between the outside tread edge and the inside tread edge, and a plurality of lateral grooves extending in a direction intersecting the plurality of circumferential grooves, wherein the plurality of circumferential grooves includes an outside shoulder circumferential groove, an outside crown circumferential groove, an inside crown circumferential groove and an inside shoulder circumferential groove which are arranged in this order from an outside tread edge side to an inside tread edge side, and a groove width W1 of the outside shoulder circumferential groove, a groove width W2 of the outside crown circumferential groove, a groove width W3 of the inside crown circumferential groove and a groove width W4 of the inside shoulder circumferential groove satisfy the following relation:

W1<W2<W3<W4.

### BRIEF DESCRIPTION OF THE DRAWINGS

FIG. 1 is a development view of a tread portion of a tire in accordance with an embodiment;

FIG. 2 is a cross-sectional view taken long the line A-A of FIG. 1;

FIG. 3 is a partial enlarged view of a crown land portion and an inside middle land portion;

FIG. 4 is a partial enlarged view of the inside middle land portion and an inside shoulder land portion;

FIG. 5 is a partial enlarged view of an outside middle land portion and an outside shoulder land portion;

FIG. 6A is a development view of a tread portion in accordance with a comparative example 1; and

FIG. 6B is a development view of a tread portion in accordance with a comparative example 2.

### DETAILED DESCRIPTION OF THE INVENTION

An embodiment of the present disclosure will be explained below with reference to the accompanying drawings.

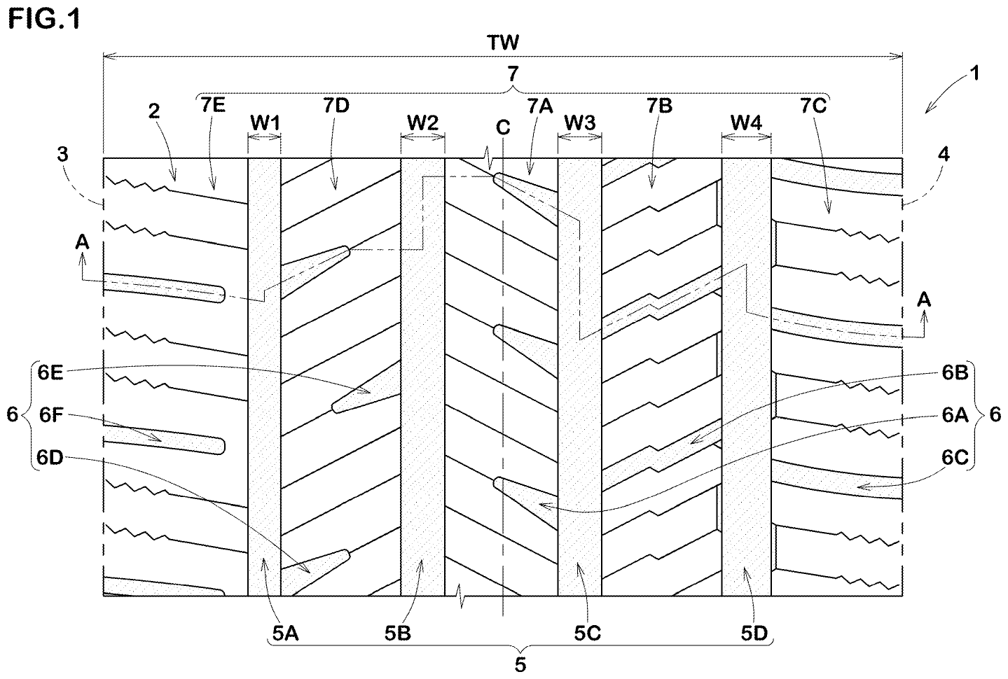

FIG. 1 illustrates a development view of a tread portion 2 of a tire 1 in accordance with an embodiment. The tire 1, for example, is preferably embodied as a passenger car pneumatic tire. However, the present disclosure is not limited to such an embodiment, and may be embodied as a heavy-duty tire, and a non-pneumatic tire that is not filled with a compressed air therein, for example.

### [Tread Portion]

The tire 1 according to the present embodiment includes the tread portion 2 having a designated mounting direction to a vehicle. The tread portion 2 includes an outside tread edge 3 located outwardly of a vehicle when being mounted to the vehicle, and an inside tread edge 4 located inwardly of a vehicle when being mounted to the vehicle. The mounting direction to a vehicle is indicated on a sidewall portion of the tire using letters or marks, for example.

The outside tread edge 3 and the inside tread edge 4 are the axial outermost edges of the ground contacting patch of the tire 1 which occurs under the condition such that the tire 1 under a normal state is grounded on a plane with a standard tire load at zero camber angles. As used herein, the “normal state” is such that the tire 1 is mounted onto a standard wheel rim with a standard pressure but loaded with no tire load. As used herein, unless otherwise noted, dimensions of portions of the tire 1 are values measured under the normal state.

As used herein, the “standard wheel rim” is a wheel rim officially approved for each tire by standards organizations on which the tire is based, wherein the standard wheel rim is the “standard rim” specified in JATMA, the “Design Rim” in TRA, and the “Measuring Rim” in ETRTO, for example.

As used herein, the “standard pressure” is a standard pressure officially approved for each tire by standards organizations on which the tire is based, wherein the standard pressure is the “maximum air pressure” in JATMA, the maximum pressure given in the “Tire Load Limits at Various Cold Inflation Pressures” table in TRA, and the “Inflation Pressure” in ETRTO, for example.

As used herein, the “standard tire load” is a tire load officially approved for each tire by standards organizations in which the tire is based, wherein the standard tire load is the “maximum load capacity” in JATMA, the maximum value given in the above-mentioned table in TRA, and the “Load Capacity” in ETRTO, for example. When the tire is a passenger car tire, the standard tire load is defined as an 88% of the above-mentioned tire load.

The tread portion 2 according to the present embodiment includes a plurality of circumferential grooves 5 extending continuously in the tire circumferential direction between the outside tread edge 3 and the inside tread edge 4, and a plurality of lateral grooves 6 extending in a direction intersecting the tire circumferential direction. Such lateral grooves 6 can form snow columns in the tire axial direction and can exert snow traction. The tread portion 2 includes a plurality of land portions 7 divided by the plurality of circumferential grooves 5. In the present embodiment, the land portions 7 include a crown land portion 7A, an inside middle land portion 7B, an inside shoulder land portion 7C, an outside middle land portion 7D, and an outside shoulder land portion 7E.

### [Circumferential Grooves]

In the present embodiment, the circumferential grooves 5 extend straight in parallel with the tire circumferential direction. Note that the circumferential grooves 5, for example, may extend in a wavy manner.

The circumferential grooves 5 include an outside shoulder circumferential groove 5A, an outside crown circumferential groove 5B, an inside crown circumferential groove 5C and an inside shoulder circumferential groove 5D which are arranged in this order from the outside tread edge 3 side to the inside tread edge 4 side.

In the present embodiment, the outside shoulder circumferential groove 5A is arranged in most outside tread edge 3 side among the plurality of circumferential grooves 5. In the present embodiment, the outside crown circumferential groove 5B is arranged between the outside shoulder circumferential groove 5A and the tire equator C. In the present embodiment, the inside shoulder circumferential groove 5D is arranged in most inside tread edge 4 side among the plurality of circumferential grooves 5. In the present embodiment, the inside crown circumferential groove 5C is arranged between the inside shoulder circumferential groove 5D and the tire equator C.

The circumferential grooves 5A to 5D as described above generate air column resonance sound when the tire travels on a dry road surface, and which tends to affect the pattern noise of the tire 1. Such pattern noise is largely affected by the air column resonance sound generated by the circumferential grooves 5 on the outside tread edge 3 side (that is, outside a vehicle). In addition, the air column resonance sound tends to increase as the groove widths of the circumferential grooves 5 increase.

In the present embodiment, a groove width W1 of the outside shoulder circumferential groove 5A, a groove width W2 of the outside crown circumferential groove 5B, a groove width W3 of the inside crown circumferential groove 5C and a groove width W4 of the inside shoulder circumferential groove 5D satisfy the following relation:

W1<W2<W3<W4.

In this embodiment, the groove widths W1 to W4 are specified as the maximum groove widths of the respective circumferential grooves.

In the present embodiment, the tire 1 with the circumferential grooves 5A to 5D which satisfy the above relation can reduce the air column resonance sound in the circumferential grooves from the inside tread edge 4 side to the outside tread edge 3 side which has a large influence on the pattern noise. As a result, the tire 1 can reduce pattern noise.

On the other hand, in the tire 1 according to the present embodiment, the groove widths W1 to W4 of the circumferential grooves 5A to 5D are set larger from the outside tread edge 3 side to the inside tread edge 4 side which has less influence on the pattern noise. As a result, the tire 1 can ensure a groove volume of the tread portion 2, so that snow traction and drainage performance of the tire can be maintained.

In order to exhibit the above effect more effectively, the groove width W1 of the outside shoulder circumferential groove 5A is preferably in a range of from 70% to 90% of the groove width W2 of the outside crown circumferential groove 5B. Further, the groove width W2 of the outside crown circumferential groove 5B is preferably in a range of 70% to 90% of the groove width W3 of the inside crown circumferential groove 5C. Furthermore, the groove width W3 of the inside crown circumferential groove 5C is preferably in a range of 70% to 90% of the groove width W4 of the inside shoulder circumferential groove 5D. In this way, the groove widths W1 to W4 are set so as to gradually decrease from the inside tread edge 4 side toward the outside tread edge 3 side, and thus reduction of drainage performance and traction performance on snow can be prevented while reducing pattern noise.

The groove widths W1 to W4 can be set appropriately as long as the above relationship is satisfied. The groove widths W1 to W4 are preferably set in a range of 2.0% to 8.0% of the tread width TW, for example. The tread width TW is the tire axial distance between the outside tread edge 3 and the inside tread edge 4.

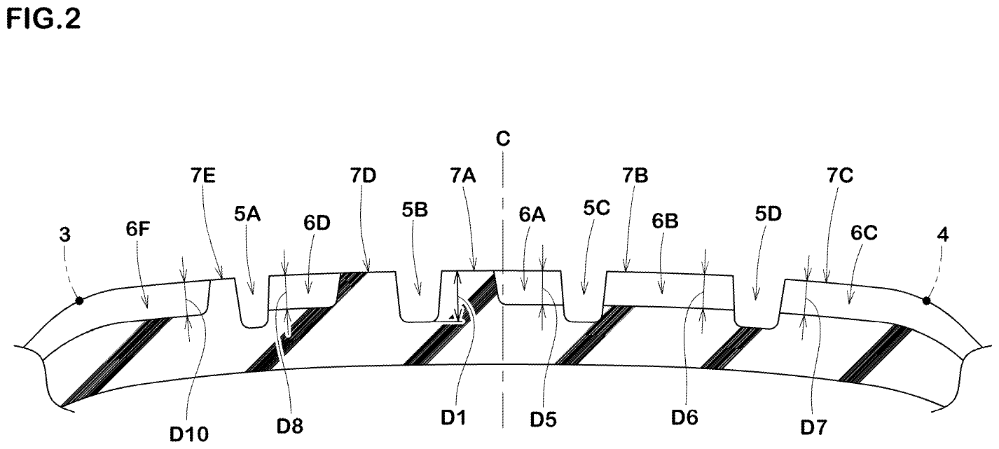

FIG. 2 illustrates a cross-sectional view taken long the line A-A of FIG. 1. As illustrated in FIG. 2, groove depths D1 (maximum groove depths) of the circumferential grooves 5A to 5D are set in a range of about 6 to 16 mm. In the present embodiment, the groove depths D1 of the circumferential grooves 5A to 5D are the same with each other. Alternatively, the same as the groove width W1 to W4 as illustrated in FIG. 1, the groove depths may be set so that the groove depths D1 decreases from the inside tread edge 4 side to the outside tread edge 3 side. This makes it possible to further reduce pattern noise.

### [Lateral Grooves]

As illustrated in FIG. 1, in the present embodiment, the lateral grooves 6 include a plurality of crown lateral grooves 6A, a plurality of inside middle lateral grooves 6B, a plurality of inside shoulder lateral grooves 6C, a plurality of first outside middle lateral grooves 6D, a plurality of second outside middle lateral grooves 6E, and a plurality of outside shoulder lateral grooves 6F.

### [Crown Lateral Grooves]

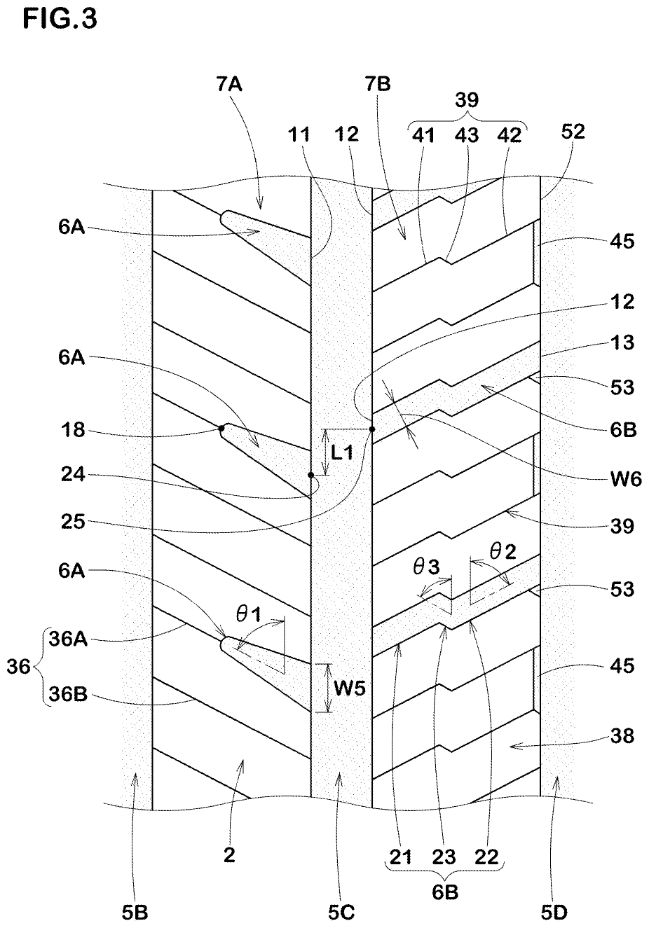

FIG. 3 illustrates a partial enlarged view of the crown land portion 7A and the inside middle land portion 7B. As illustrated in FIG. 3, the crown lateral grooves 6A extend from the inside crown circumferential groove 5C and terminate within the crown land portion 7A. The crown lateral grooves 6A are spaced in the tire circumferential direction on the crown land portion 7A. The crown lateral grooves 6A have respective first openings 11 that open to the inside crown circumferential groove 5C.

In the present embodiment, the crown lateral grooves 6A, for example, have less groove volume than that of lateral grooves that connect the inside crown circumferential groove 5C and the outside crown circumferential groove 5B, thus reducing air pumping noise when grounding. Further, the first openings 11 open to the circumferential groove on the inside tread edge 4 side (shown in FIG. 1) which has a small effect on pattern noise, and pattern noise of the tire can be reduced effectively. Furthermore, the crown lateral grooves 6A, when driving on snow, can compact snow from the first openings 11 toward axially inner ends 18 thereof, providing powerful snow traction.

In the present embodiment, a groove width of each crown lateral groove 6A decreases from the first opening 11 to the axially inner end 18 continuously. Thus, the crown lateral grooves 6A can compact snow firmly from the first openings 11 toward the axially inner ends 18, providing powerful snow traction.

Preferably, the maximum groove width W5 of each crown lateral groove 6A is set in a range of from about 3.5% to about 5.0% of the tread width TW (shown in FIG. 1). As illustrated in FIG. 2, preferably, the groove depth (the maximum groove depth) D5 of each crown lateral groove 6A is in a range of from 50% to 90% of the groove depth D1 of the inside crown circumferential groove 5C (not illustrated).

As illustrated in FIG. 3, in the present embodiment, the crown lateral grooves 6A are inclined at an angle with respect to the depth) tire axial direction. Such crown lateral grooves 6A have edge components in the tire circumferential direction and the tire axial direction, improving snow traction as well as cornering performance. In addition, the crown lateral grooves 6A, in a region between the first openings 11 and the inner ends 18, can stagger the timing of contact with and release from the ground. Thus, the crown lateral grooves 6A can reduce the pumping noise when grounding and reduce the pattern noise. In order to further improve the above-mentioned effect, an angle θ1 of the crown lateral grooves 6A is preferably in a range of 50 to 70 degrees with respect to the tire circumferential direction. Note that the angle of the lateral grooves 6 is measured using the groove centerlines of the lateral grooves 6.

### [Inside Middle Lateral Grooves]

The inside middle lateral grooves 6B extend from the inside shoulder circumferential groove 5D to the inside crown circumferential groove 5C. The inside middle lateral grooves 6B, in the inside middle land portion 7B, are spaced in the tire circumferential direction. The inside middle lateral grooves 6B have respective second openings 12 that open to the inside crown circumferential groove 5C and respective third openings 13 that open to the inside shoulder circumferential groove 5D.

Since the inside middle lateral grooves 6B connect the inside shoulder circumferential groove 5D and the inside crown circumferential groove 5C, the inside middle land portion 7B can form axially long snow columns. Thus, the inside middle lateral grooves 6B can be helpful to improve snow traction. In addition, the inside middle lateral grooves 6B are provided on the inside tread edge 4 (shown in FIG. 1) side which has a small effect on pattern noise. Thus, the inside middle lateral grooves 6B can reduce the effect of air pumping noise on the pattern noise.

In order to further improve the above-mentioned effect, the maximum groove width W6 of each inside middle lateral grooves 6B is preferably set in a range of about 1.5% to about 3.5% of the tread width TW (shown in FIG. 1). As illustrated in FIG. 2, a groove depth (the maximum groove depth) D6 of each inside middle lateral groove 6B is preferably in a range of 50% to 90% of the groove depth D1 of the inside crown circumferential groove 5C (not illustrated).

As illustrated in FIG. 3, in the present embodiment, each inside middle lateral groove 6B includes a first portion 21, a second portion 22 and a third portion 23. The first portion 21 extends from the second opening 12 toward the inside shoulder circumferential groove 5D. The second portion 22 extends from the third opening 13 toward the inside crown circumferential groove 5C.

The first portion 21 and the second portion 22 are inclined with respect to the tire circumferential direction. In the present embodiment, the first portion 21 and the second portion 22, with respect to the tire circumferential direction, are inclined in an opposite direction (i.e., an intersecting direction) to the crown lateral grooves 6A.

The third portion 23 connects the first portion 21 and the second portion 22 in a crank manner. The third portion 23 is inclined with respect to the tire circumferential direction.

In the present embodiment, each inside middle lateral groove 6B can form a crank shaped snow column, providing powerful snow traction. Further, the first portions 21, the second portions 22 and the third portions 23 have edge components in the tire circumferential direction and the tire axial direction, improving snow traction as well as cornering performance. Furthermore, the inside middle lateral grooves 6B can reduce air pumping noise when grounding, reducing pattern noise. In order to further improve the above-mentioned effect, an angle θ2 of the first portions 21 and the second portions 22 is preferably in a range of from 50 to 70 degrees with respect to the tire circumferential direction. Further, an angle θ3 of the third portions 23 is preferably in a range of from 30 to 50 degrees with respect to the tire circumferential direction.

In the present embodiment, the respective first openings 11 of the crown lateral grooves 6A are arranged in different locations in the tire circumferential direction from the respective second openings 12 of the inside middle lateral grooves 6B so as not to face the respective second openings 12 in the tire axial direction. Thus, the crown lateral grooves 6A and the inside middle lateral grooves 6B can stagger the timing of contact with and release from the ground with each other, resulting in reducing air pumping noise effectively when grounding. Therefore, the tire 1 according to the present embodiment can reduce pattern noise. In order to further improve the above-mentioned effect, a minimum distance L1 in the tire circumferential direction between the circumferentially adjacent first opening 11 and the second opening 12 is preferably in a range of from 3% to 7% of the tread width TW (shown in FIG. 1). Note that the minimum distance L1 is measured as a circumferential distance between a first intersection 24 and a second intersection 25, wherein the first intersection 24 is an intersection of the groove centerline of the crown lateral groove 6A and the first opening 11, and the second intersection 25 is an intersection of the groove centerline of the inside middle lateral groove 6B and the second opening 12.

Preferably, a sum of a total value of maximum groove widths W5 of the plurality of crown lateral grooves 6A and a total value of maximum groove widths W6 of the inside middle lateral grooves 6B is in a range of 30% to 40% of a circumferential length of the tread portion 2 (shown in FIG. 1). By setting the above-mentioned sum to equal to or more than 30% of the circumferential length, a total groove volume of the crown lateral grooves 6A and the inside middle lateral grooves 6B can be maintained sufficiently, and snow traction can be improved. On the other hand, by setting the above-mentioned sum to equal to or less than 40% of the circumferential length, an increase of air pumping noise can be suppressed. From these viewpoints, the above-mentioned sum is preferably equal to or more than 32% of the circumferential length, and is preferably equal to or less than 38% of the circumferential length. Note that the circumferential length of the tread portion is specified as a tire circumference in the tire equator C.

### [Inside Shoulder Lateral Grooves]

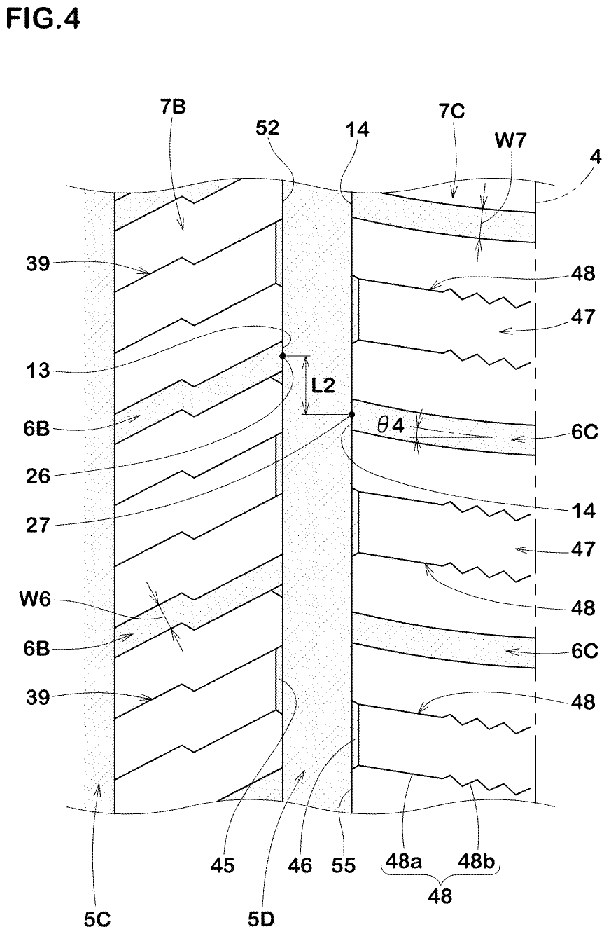

FIG. 4 illustrates a partial enlarged view of the inside middle land portion 7B and the inside shoulder land portion 7C. As illustrated in FIG. 4, the inside shoulder lateral grooves 6C extend from the inside shoulder circumferential groove 5D to the inside tread edge 4. The inside shoulder lateral grooves 6C are spaced in the tire circumferential direction on the inside middle land portion 7B. The inside shoulder lateral grooves 6C have respective fourth openings 14 that open to the inside shoulder circumferential groove 5D.

Since the inside shoulder lateral grooves 6C connect the inside shoulder circumferential groove 5D and the inside tread edge 4, the inside shoulder land portion 7C can form axially long snow columns Thus, the inside shoulder lateral grooves 6C can be helpful to improve snow traction. In addition, the inside shoulder lateral grooves 6C are provided on the inside tread edge 4 side which has a small effect on pattern noise. Thus, the inside shoulder lateral grooves 6C can reduce the effect of air pumping noise on the pattern noise.

In order to further improve the above-mentioned effect, the maximum groove width W7 of each inside shoulder lateral grooves 6C is preferably set in a range of about 2.0% to about 4.0% of the tread width TW (shown in FIG. 1). As illustrated in FIG. 2, a groove depth (the maximum groove depth) D7 of each inside shoulder lateral groove 6C is preferably in a range of 50% to 90% of the groove depth D1 of the inside shoulder circumferential groove 5D (not illustrated).

In the present embodiment, the inside shoulder lateral grooves 6C are curved in such a manner that an angle θ4 with respect to the tire axial direction decreases continuously from the fourth openings 14 toward the inside tread edge 4. The inside shoulder lateral grooves 6C according to the present embodiment are inclined in an opposite direction (an intersecting direction) of the inside middle lateral grooves 6B (e.g., the first portions 21 and the second portions 22 shown in FIG. 3) with respect to the tire circumferential direction. The inside shoulder lateral grooves 6C can provide edge components in the tire circumferential direction and the tire axial direction and form large snow columns in the tire axial direction. Thus, snow traction as well as cornering performance can be improved. In order to further improve the effect, the angle θ4 is preferably in a range of 5 to 45 degrees.

In the present embodiment, the respective third openings 13 are arranged in different locations in the tire circumferential direction from the respective fourth openings 14 so as not to face the respective fourth openings 14 in the tire axial direction. Thus, the inside middle lateral grooves 6B and the inside shoulder lateral grooves 6C can stagger the timing of contact with and release from the ground with each other, resulting in reducing air pumping noise effectively when grounding. Therefore, the tire 1 according to the present embodiment can reduce pattern noise. In order to further improve the above-mentioned effect, a minimum distance L2 in the tire circumferential direction between the circumferentially adjacent third opening 13 and the fourth opening 14 is preferably in a range of from 4% to 8% of the tread width TW (shown in FIG. 1). Note that the minimum distance L2 is measured as a circumferential distance between a third intersection 26 and fourth intersection 27, wherein the third intersection 26 is an intersection of the groove centerline of the inside middle lateral grooves 6B and the third opening 13, and the fourth intersection 27 is an intersection of the groove centerline of the inside shoulder lateral grooves 6C and the fourth opening 14.

Preferably, a sum of a total value of maximum groove widths W7 of the plurality of inside shoulder lateral grooves 6C and a total value of maximum groove widths W6 of the inside middle lateral grooves 6B is in a range of 20% to 30% of the circumferential length of the tread portion 2. By setting the above-mentioned sum to equal to or more than 20% of the circumferential length of the tread portion, a total groove volume of the inside shoulder lateral grooves 6C and the inside middle lateral grooves 6B can be maintained sufficiently, and snow traction can be improved. By setting the above-mentioned sum to equal to or less than 30% of the circumferential length of the tread portion, an increase of air pumping noise can be suppressed. From these viewpoints, the above-mentioned sum is preferably equal to or more than 22% of the circumferential length, and is preferably equal to or less than 28% of the circumferential length of the tread portion.

### [First Outside Middle Lateral Grooves]

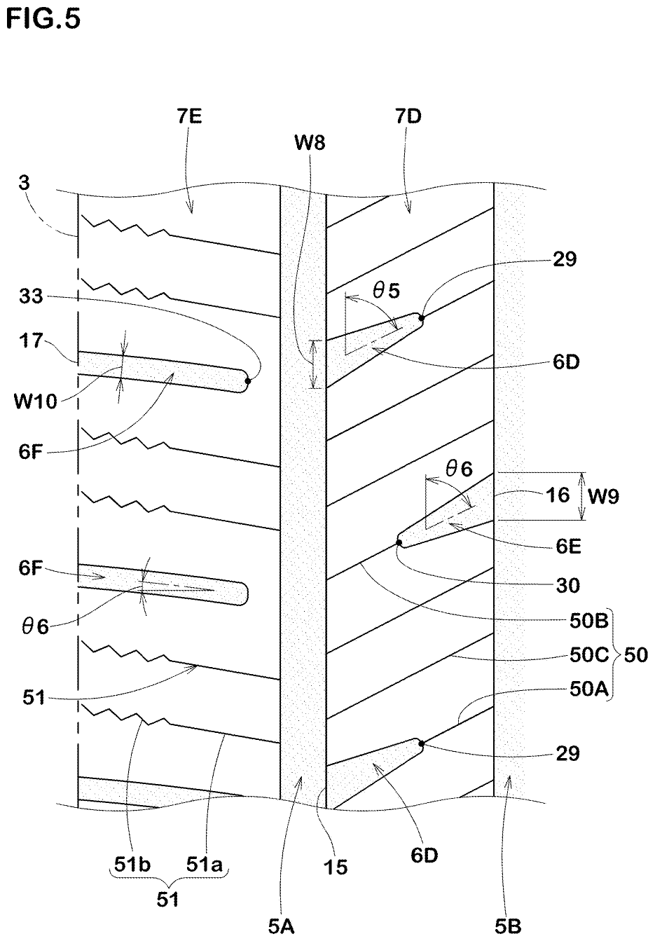

FIG. 5 illustrates a partial enlarged view of the outside middle land portion 7D and the outside shoulder land portion 7E. As illustrated in FIG. 5, the first outside middle lateral grooves 6D extend from the outside shoulder circumferential groove 5A and terminate within the outside middle land portion 7D. The first outside middle lateral grooves 6D are spaced in the tire circumferential direction on the outside middle land portion 7D. The first outside middle lateral grooves 6D have respective fifth openings 15 that open to the outside shoulder circumferential groove 5A.

In the present embodiment, the first outside middle lateral grooves 6D, for example, have less groove volume than that of lateral grooves that connect the outside shoulder circumferential groove 5A and the outside crown circumferential groove 5B. Thus, the first outside middle lateral grooves 6D can reduce pumping noise when grounding on the outside tread edge 3 side, which has a large influence on the pattern noise. In addition, the first outside middle lateral grooves 6D can compact the snow column from the fifth openings 15 toward the inner equal edge 29 in the tire axial direction, providing powerful snow traction.

In the present embodiment, a groove width of each first outside middle lateral groove 6D decreases from the fifth opening 15 to an axially inner end 29 thereof. Thus, the first outside middle lateral grooves 6D can compact snow firmly from the fifth openings 15 toward the axially inner ends 29, providing powerful snow traction more effectively.

Preferably, the maximum groove width W8 of each first outside middle lateral groove 6D is in a range of from 3.5% to 5.0% of the tread width TW (shown in FIG. 1). As illustrated in FIG. 2, a groove depth (the maximum groove depth) D8 of each first outside middle lateral groove 6D is preferably in a range of 50% to 90% of the groove depth D1 of the outside shoulder circumferential groove 5A (not illustrated).

As illustrated in FIG. 5, in the present embodiment, the first outside middle lateral grooves 6D are inclined at an angle with respect to the tire axial direction. Such first outside middle lateral grooves 6D have edge components in the tire circumferential direction and the tire axial direction, improving snow traction as well as cornering performance. In addition, the first outside middle lateral grooves 6D, in a region between the fifth openings 15 and the inner ends 29, can stagger the timing of contact with and release from the ground. Thus, the first outside middle lateral grooves 6D can reduce air pumping noise when grounding on the outside tread edge 3 side which has a large influence on the pattern noise. As a result, the tire 1 can reduce pattern noise. In order to further improve the effect, an angle θ5 of the first outside middle lateral grooves 6D is preferably in a range of 50 to 70 degrees with respect to the tire circumferential direction.

### [Second Outside Middle Lateral Grooves]

The second outside middle lateral grooves 6E extend from the outside crown circumferential groove 5B and terminate within the outside middle land portion 7D. The second outside middle lateral grooves 6E are spaced in the tire circumferential direction on the outside middle land portion 7D. The second outside middle lateral grooves 6E have respective sixth openings 16 that open to the outside crown circumferential groove 5B.

In the present embodiment, the second outside middle lateral grooves 6E, for example, have less groove volume than that of lateral grooves that connect the outside crown circumferential groove 5B and the outside shoulder circumferential groove 5A. Thus, the second outside middle lateral grooves 6E can reduce air pumping noise when grounding on the outside tread edge 3 side which has a large influence on the pattern noise. In addition, the second outside middle lateral grooves 6E can compact snow columns from the sixth openings 16 toward the inner end 30 in the tire axial direction, and can exert snow traction.

In the present embodiment, a groove width of each second outside middle lateral groove 6E decreases continuously from the sixth opening 16 to an axially inner end 30 thereof. Thus, the second outside middle lateral grooves 6E can compact snow columns more firmly from the sixth openings 16 toward the inner ends 30, and can effectively exert snow traction.

Preferably, the maximum groove width W9 of each second outside middle lateral groove 6E is set in the same range as the maximum groove width W8 of the first outside middle lateral grooves 6D. In addition, a groove depth (the maximum groove depth, and not illustrated) of each second outside middle lateral groove is preferably set in the same range as the groove depth D8 (shown in FIG. 2) of the first outside middle lateral grooves 6D.

In the present embodiment, the second outside middle lateral grooves 6E are inclined at an angle with respect to the tire axial direction. Such second outside middle lateral grooves 6E have edge components in the tire circumferential direction and the tire axial direction, improving snow traction and cornering performance. Further, in the present embodiment, the second outside middle lateral grooves 6E are arranged in parallel with the first outside middle lateral grooves 6D. Thus, the second outside middle lateral grooves 6E can exhibit the edge component in the same direction as the first outside middle lateral grooves 6D, so that snow traction and cornering performance can be further improved.

The second outside middle lateral grooves 6E, in a region between the sixth openings 16 and the inner ends 30, can stagger the timing of contact with and release from the ground. Thus, the second outside middle lateral grooves 6E can reduce air pumping noise when grounding on the outside tread edge 3 side which has a large influence on the pattern noise. As a result, the tire 1 can reduce pattern noise. In order to further improve the effect, an angle θ6 of the second outside middle lateral grooves 6E with respect to the tire circumferential direction is preferably set in the same range as the angle θ5 of the first outside middle lateral grooves 6D.

In the present embodiment, the respective fifth openings 15 of the first outside middle lateral grooves 6D are arranged in different locations in the tire circumferential direction from the respective sixth openings 16 of the second outside middle lateral grooves 6E. Thus, the first outside middle lateral grooves 6D and the second outside middle lateral grooves 6E are arranged alternately in the tire circumferential direction, and the first outside middle lateral grooves 6D and the second outside middle lateral grooves 6E can stagger the timing of contact with and release from the ground with each other. As a result, the first outside middle lateral grooves 6D and the second outside middle lateral grooves 6E can effectively reduce air pumping sound when grounding on the outside tread edge 3 side which has a large influence on the pattern noise. Therefore, the tire 1 according to the present embodiment can reduce pattern noise.

### [Outside Shoulder Lateral Grooves]

The outside shoulder lateral grooves 6F extend from the outside tread edge 3 and terminate within the outside shoulder land portion 7E. The outside shoulder lateral grooves 6F are spaced in the tire circumferential direction on the outside shoulder land portion 7E. The outside shoulder lateral grooves 6F have respective seventh openings 17 that open to the outside tread edge 3.

The outside shoulder lateral grooves 6F, for example, have less groove volume than that of lateral grooves that connect the outside tread edge 3 and the outside shoulder circumferential groove 5A. Thus, the outside shoulder lateral grooves 6F can reduce air pumping sound when grounding on the arranged outside tread edge 3 side which has a large influence on the pattern noise. In addition, the outside shoulder lateral grooves 6F can compact the snow columns from the seventh openings 17 toward axially inner end 33 thereof in the tire axial direction, and can exert powerful snow traction.

In the present embodiment, the maximum groove width W10 of each outside shoulder lateral groove 6F is smaller than the maximum groove width W7 (shown in FIG. 4) of each inside shoulder lateral groove. Thus, the outside shoulder lateral grooves 6F can effectively reduce air pumping sound when grounding on the outside tread edge 3 side which has a large influence on the pattern noise.

In order to further improve the above-mentioned effect, the maximum groove width W10 of each outside shoulder lateral groove 6F is preferably in a range of from 1.0% to 2.5% of the tread width TW (shown in FIG. 1). As illustrated in FIG. 2, a groove depth D10 of the outside shoulder lateral grooves 6F is preferably in a range of 50% to 90% of the groove depth D1 of the outside shoulder circumferential groove 5A (not illustrated).

As illustrated in FIG. 5, in the present embodiment, the outside shoulder lateral grooves 6F are inclined at an angle with respect to the tire axial direction. In the present embodiment, the outside shoulder lateral grooves 6F are inclined in an opposite direction (intersecting direction) to the first outside middle lateral grooves 6D with respect to the tire circumferential direction. Such outside shoulder lateral grooves 6F can form large snow columns extending in the tire axial direction while exhibiting the edge effect of the tire circumferential direction and the tire axial direction, and provide powerful snow traction and better cornering performance. In order to exert such an effect effectively, the angle θ6 is preferably in a range of 5 to 45 degrees.

In the present embodiment, as shown in FIGS. 3 to 5, the first openings 11, the second openings 12, the third openings 13, the fourth openings 14, the fifth openings 15, the sixth openings 16, and the seventh openings 17 are arranged in different locations in the tire circumferential direction from each other. Thus, the crown lateral grooves 6A, the inside middle lateral grooves 6B, the inside shoulder lateral grooves 6C, the first outside middle lateral grooves 6D, the second outside middle lateral grooves 6E and the outside shoulder lateral grooves 6F can stagger the timing of contact with and release from the ground from each other. Therefore, the tire 1 according to the present embodiment can reduce air pumping noise when grounding effectively so that the pattern noise can be reduced effectively.

### [Crown Land Portion]

As illustrated in FIG. 3, in the present embodiment, the crown land portion 7A is defined between the outside crown circumferential groove 5B and the inside crown circumferential groove 5C. The crown land portion 7A is provided with a plurality of crown sipes 36. The crown sipes 36 can increase a total edge length on the crown land portion 7A, improving snow traction.

As used herein, “sipe” means an incision that has a width less than 1.5 mm. Preferably, a width of sipe, for example, is in a range of 0.5 to 1.0 mm. A depth of sipe (not illustrated) is preferably in a range of 30% to 70% of the groove depth D1 of the outside crown circumferential groove 5B (not illustrated).

In the present embodiment, the crown sipes 36 include first crown sipes 36A extending from the inner ends 18 of the crown lateral grooves 6A to the outside crown circumferential groove 5B, and second crown sipes 36B extending from the inside crown circumferential groove 5C to the outside crown circumferential groove 5B.

In the present embodiment, the first crown sipes 36A and the second crown sipes 36B are inclined in parallel with the crown lateral grooves 6A. The first crown sipes 36A and the second crown sipes 36B have edge components in the tire circumferential direction and the tire axial direction, improving snow traction and cornering performance. In addition, the first crown sipes 36A can increase deformation of the crown lateral grooves 6A during running (when coming into contact with the ground), and can efficiently discharge snow and water from the crown lateral grooves 6A, thus enhancing snow traction.

### [Inside Middle Land Portion]

The inside middle land portion 7B is defined between the inside shoulder circumferential groove 5D and the inside crown circumferential groove 5C. In the present embodiment, the inside middle land portion 7B is divided into a plurality of inside middle blocks 38 by the inside middle lateral grooves 6B.

Each inside middle block 38 is provided with one or more inside middle sipes 39 that connect the inside shoulder circumferential groove 5D and the inside crown circumferential groove 5C. The inside middle sipes 39 can increase an edge length of the inside middle block 38, improving snow traction.

In the present embodiment, the inside middle sipes 39, as with the inside middle lateral grooves 6B, each include a first portion 41, a second portion 42 and a third portion 43 which are arranged in a crank manner. The first portion 41 are inclined in parallel with the first portions 21 of the inside middle lateral grooves 6B. The second portion 42 is inclined in parallel with the second portions 22 of the inside middle lateral grooves 6B. The third portion 43 is inclined in parallel with the third portions 23 of the inside middle lateral grooves 6B. Each inside middle sipe 39, as with the inside middle lateral grooves 6B, can provide a crank shaped edge component that can improve snow traction.

In the present embodiment, the inside middle blocks 38 are provided with first recesses 45 on sidewalls 52 thereof on the inside shoulder circumferential groove 5D side. In the present embodiment, the first recesses 45 each have both circumferential ends to which a pair of the inside middle sipes 39 and 39 is connected. The first recesses 45 each can not only form a large snow column in conjunction with the inside shoulder circumferential groove 5D, but also help to discharge the snow column from the inside shoulder circumferential groove 5D.

In addition, the inside middle blocks 38 are provided with chamfer portions 53 on block corners between the sidewalls 52 and the inside middle lateral grooves 6B. Such chamfer portions 53 can help to discharge snow columns from the inside middle lateral grooves 6B while suppressing damage of the block corners.

### [Inside Shoulder Land Portion]

As illustrated in FIG. 4, the inside shoulder land portion 7C is defined between the inside shoulder circumferential groove 5D and the inside tread edge 4. In the present embodiment, the inside shoulder land portion 7C is divided into a plurality of inside shoulder blocks 47 by the inside shoulder lateral grooves 6C.

Each inside shoulder block 47 is provided with a plurality of inside shoulder sipes 48 extending from the inside shoulder circumferential groove 5D to the inside tread edge 4. Such inside shoulder sipes 48 can increase an edge length of each inside shoulder block 47, improving snow traction.

In the present embodiment, the inside shoulder sipes 48 are inclined at an angle with respect to the tire axial direction (e.g., parallel with the inside shoulder lateral grooves 6C). Such inside shoulder sipes 48 can provide edge components in the tire circumferential direction and the tire axial direction, improving snow traction and cornering performance.

In the present embodiment, each inside shoulder sipe 48 includes a first portion 48a extending straight and a second portion 48b extending in a zigzag manner. The second portion 48b has a pair of sipe walls that can engage with each other when grounding, maintaining rigidity of the inside shoulder land portion 7C and improving snow traction.

In the present embodiment, the inside shoulder blocks 47 are provided with second recesses 46 on sidewalls 55 thereof on the inside shoulder circumferential groove 5D side. In the present embodiment, each second recesses 46 has a pair of circumferential both ends to which a pair of the inside shoulder sipes 48 and 48 is connected. Such second recesses 46 in conjunction with the first recesses 45 of the inside middle blocks 38 and the inside shoulder circumferential groove 5D can not only form large snow columns, but also help to discharge the snow columns from the inside shoulder circumferential groove 5D. In order to further improve the above-mentioned effect, the second recesses 46 are preferably arranged in different locations in the tire circumferential direction from the first recesses 45.

### [Outside Middle Land Portion]

As illustrated in FIG. 5, the outside middle land portion 7D is defined between the outside shoulder circumferential groove 5A and the outside crown circumferential groove 5B. The outside middle land portion 7D is provided with a plurality of outside middle sipes 50. The outside middle sipes 50 can increase a total edge length on the outside middle land portion 7D, improving snow traction.

In the present embodiment, the outside middle sipes 50 include first outside middle sipes 50A, second outside middle sipes 50B, and third outside middle sipes 50C. The first outside middle sipes 50A extend from the inner ends 29 of the first outside middle lateral grooves 6D to the outside crown circumferential groove 5B. The second outside middle sipes 50B extend from the inner ends 30 of the second outside middle lateral grooves 6E to the outside shoulder circumferential groove 5A. The third outside middle sipes 50C extend from the outside shoulder circumferential groove 5A to the outside crown circumferential groove 5B.

In the present embodiment, the first outside middle sipes 50A, the second outside middle sipes 50B and the third outside middle sipes 50C are inclined in parallel with the first outside middle lateral grooves 6D and the second outside middle lateral grooves 6E. The first outside middle sipes 50A, the second outside middle sipes 50B and the third outside middle sipes 50C have edge components in the tire circumferential direction and the tire axial direction, improving snow traction and cornering performance.

The first outside middle sipes 50A can increase the deformation of the first outside middle lateral grooves 6D when running (when coming into contact with the ground), and can efficiently discharge snow and water from the first outside middle lateral grooves 6D. In addition, the second outside middle sipes 50B can increase the deformation of the second outside middle lateral grooves 6E when running (when coming into contact with the ground), and can efficiently discharge snow and water from the second outside middle lateral grooves 6E. Thus, the first outside middle sipes 50A and the second outside middle sipes 50B can improve snow traction.

As illustrated in FIG. 1, a land ratio of the outside middle land portion 7D is preferably in a range of 80% to 120% of a land ratio of the inside middle land portion 7B. As used herein, a land ratio of one land portion 7 is a ratio (S/Sa) of an area S of a ground contacting surface of the land portion 7 to an area Sa of a virtual ground contacting surface obtained by filling all the grooves at the land portion 7.

When the land ratio of the outside middle land portion 7D is set equal to or more than 80% of the land ratio of the inside middle land portion 7B, rigidity of the outside middle land portion 7D can be maintained, and snow traction and cornering performance can be exerted. Further, the outside middle land portion 7D, which has a relatively large effect on pattern noise with respect to the inside middle land portion 7B, is maintained at a high land ratio. Thus, it is possible to prevent the negative proportions of the first outside middle lateral grooves 6D and the second outside middle lateral grooves 6E from increasing. As a result, a decrease in snow traction and steering stability can be suppressed while reducing pattern noise.

When the land ratio of the outside middle land portion 7D is set equal to less than 120% of the inside middle land portion 7B, it is possible to prevent the rigidity difference from the inside middle land portion 7B from becoming large while preventing the rigidity of the outside middle land portion 7D from becoming higher than necessary. From this point of view, the land ratio of the outside middle land portion 7D is preferably equal to or more than 90% of the land ratio of the inside middle land portion 7B, and preferably equal to or less than 110%.

### [Outside Shoulder Land Portion]

As illustrated in FIG. 5, the outside shoulder land portion 7E is defined between the outside shoulder circumferential groove 5A and the outside tread edge 3. The outside shoulder land portion 7E is provided with a plurality of outside shoulder sipes 51 extending from the outside shoulder circumferential groove 5A to the outside tread edge 3. The outside shoulder sipes 51 can increase a total edge length on the outside shoulder land portion 7E, improving snow traction.

In the present embodiment, the outside shoulder sipes 51 are inclined with respect to the tire axial direction (e.g., in parallel with the outside shoulder lateral grooves 6F). Such outside shoulder sipes 51 have edge components in the tire circumferential direction and the tire axial direction, improving snow traction and cornering performance.

In the present embodiment, each outside shoulder sipe 51 includes a first portion 51a extending straight and a second portion 51b extending in a zigzag manner. The second portion 51b has a pair of sipe walls that can engage with each other when grounding, maintaining rigidity of the outside shoulder land portion 7E and improving snow traction.

As illustrated in FIG. 1, a land ratio of the outside shoulder land portion 7E is preferably in a range of 100% to 150% of a land ratio of the inside shoulder land portion 7C. When the land ratio of the outside shoulder land portion 7E is set equal to or more than 100% of the land ratio of the inside shoulder land portion 7C, rigidity of the outside shoulder land portion 7E can be maintained, and snow traction and cornering performance can be exerted. Further, the outside shoulder land portion 7E, which has a relatively large effect on pattern noise with respect to the cornering inside shoulder land portion 7C, is maintained at a high land ratio. Thus, it is possible to prevent the negative proportions of the outside shoulder lateral grooves 6F from increasing. As a result, a decrease in snow traction and steering stability can be suppressed while reducing pattern noise.

When the land ratio of the outside shoulder land portion 7E is set equal to or less than 150% of the land ratio of the inside shoulder land portion 7C, it is possible to prevent the rigidity difference from the inside shoulder land portion 7C from becoming large while preventing the rigidity of the outside shoulder land portion 7E from becoming higher than necessary. From this point of view, the land ratio of the outside shoulder land portion 7E is preferably equal to or more than 110% of the land ratio of the inside shoulder land portion 7C, and preferably equal to or less than 140%.

While the particularly preferable embodiments in accordance with the present disclosure have been described in detail, the present disclosure is not limited to the illustrated embodiments, but can be modified and carried out in various aspects within the scope of the claims.

### EXAMPLE

### Example A

Tires (Examples 1 to 4) having the basic structure shown in FIG. 1 were prototyped based on the details shown in Table 1. The tires have the groove widths W1, W2, W3 and W4 of the outside shoulder circumferential groove, the outside crown circumferential groove, the inside crown circumferential groove and the inside shoulder circumferential groove, respectively, satisfying the following relation:

W1<W2<W3<W4.

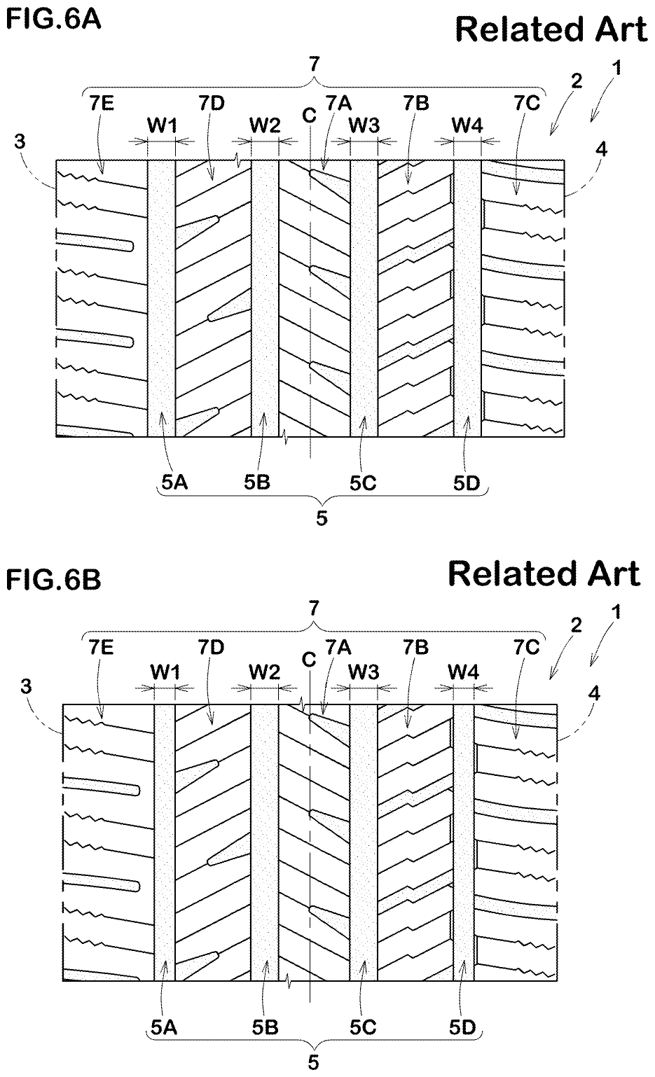

For comparison, as illustrated in FIG. 6A, a tire whose groove widths satisfy the relation of “W1=W2=W3=W4” (Comparative Example 1), and as illustrated in FIG. 6B, a tire whose groove widths satisfy the relation of “W2=W3>W1=W4” (Comparative Example 2) were also prototyped.

Then, pattern noise and snow traction were evaluated for each prototype tire. The common specifications and test methods are as follows. The test results are shown in Table 1.
Tire size: 225/65R17
Rim size: 17×6.5J
Inner pressure: 230 kPa
Test vehicle: four-wheel-drive vehicle (2000 cc)
Tread width TW: 210 mm
Each circumferential groove depth D1: 8.5 mm
Lateral groove depths D5 and D7 to D10: 6.8 mm
Lateral groove depth D6: 6.0 mm
(Total value of maximum groove widths of crown lateral grooves+total value of maximum groove widths of inside middle lateral grooves)/circumferential length of tread portion: 35%
(Total value of maximum groove widths of inside shoulder lateral grooves+total value of maximum groove widths of inside middle lateral grooves)/circumferential length of tread portion: 25%
Land ratio of outside middle land portion/land ratio of inside middle land portion: 100%
Land ratio of outside shoulder land portion/land ratio of inside shoulder land portion: 110%

### Pattern Noise Test:

Each test tire was mounted on the above rim, and after the internal pressure was applied, it was mounted on all the wheels of the test vehicle. Then, the pattern noise when a test driver got on board and ran on a dry paved road surface was evaluated by the sensuality of the test driver. The test results are represented by an index with Comparative Example 1 as 100. The larger the value, the smaller the pattern noise and the better the noise performance.

### Snow Traction Test:

Each test tire was mounted on the above rim, and after the internal pressure was applied, it was mounted on all the wheels of the test vehicle. Then, the distance when a test driver got on board and accelerated from 5 mph to 20 mph on a snow-packed course was measured. The test results are represented by an index with Comparative Example 1 as 100, and the larger the value, the better the snow traction.

TABLE 1

| | Ref. 1 | Ref. 2 | Ex. 1 | Ex. 2 | Ex. 3 | Ex. 4 |
|---|---|---|---|---|---|---|
| Tread portion development view | FIG. 6A | FIG. 6B | FIG. 1 | FIG. 1 | FIG. 1 | FIG. 1 |
| Misalignment of first and second openings | presence | presence | presence | none | presence | presence |
| Misalignment of third and fourth openings | presence | presence | presence | presence | none | presence |
| Misalignment of fifth and sixth openings | presence | presence | presence | presence | presence | none |
| Pattern noise performance (index) | 100 | 105 | 130 | 120 | 122 | 115 |
| Snow traction performance (index) | 100 | 95 | 120 | 125 | 123 | 127 |
| Total evaluation (index) | 200 | 200 | 250 | 245 | 245 | 242 |

As a result of the test, it is confirmed that the example tires can reduce pattern noise while maintaining snow traction compared to the comparative examples. Furthermore, the example 1 having the misalignment of the first openings and the second openings, the misalignment of the third openings and the fourth openings, and the misalignment of the fifth openings and the sixth openings can significantly reduce pattern noise compared to the other examples.

### Example B

Tires (Examples 1 and 5 to 12) having the basic structure shown in FIG. 1 were prototyped based on the details shown in Table 2. The tires have the groove widths W1, W2, W3 and W4 of the outside shoulder circumferential groove, the outside crown circumferential groove, the inside crown circumferential groove and the inside shoulder circumferential groove, respectively, satisfying the following relation:

W1<W2<W3<W4.

The test results are shown in Table 2. The common specifications are the same as in Example A, except for the specifications in Table 2.

TABLE 2

| | Ex. 5 | Ex. 6 | Ex. 1 | Ex. 7 | Ex. 8 | Ex. 9 | Ex. 10 | Ex. 11 | Ex. 12 |
|---|---|---|---|---|---|---|---|---|---|
| (Total value of maximum groove widths of | 25 | 30 | 35 | 40 | 45 | 35 | 35 | 35 | 35 |
| crown lateral grooves + total value of maximum | | | | | | | | | |
| groove widths of inside middle lateral grooves)/ | | | | | | | | | |
| circumferential length of tread portion (%) | | | | | | | | | |
| (Total value of maximum groove widths of | 25 | 25 | 25 | 25 | 25 | 18 | 20 | 30 | 32 |
| inside shoulder lateral grooves + total value of | | | | | | | | | |
| maximum groove widths of inside middle | | | | | | | | | |
| lateral grooves)/circumferential length of | | | | | | | | | |
| tread portion (%) | | | | | | | | | |
| Pattern noise performance (index) | 134 | 131 | 130 | 127 | 120 | 133 | 132 | 128 | 122 |
| Snow traction performance (index) | 112 | 118 | 120 | 122 | 124 | 110 | 117 | 121 | 125 |
| Total evaluation (index) | 246 | 249 | 250 | 249 | 244 | 243 | 249 | 249 | 247 |

As a result of the test, it is confirmed that Examples 1, 6 and 7, in which the ratio of the sum of the maximum groove widths of the crown lateral grooves and the inside middle lateral grooves to the circumferential of the tread portion falls in a preferable range, can reduce the pattern noise while maintaining snow traction compared to Examples 5 and 8. It is also confirmed that Examples 1, 10 and 11, in which the ratio of the sum of the maximum groove widths of the inside shoulder lateral grooves and the inside middle lateral grooves to the circumferential of the tread portion falls in a preferable range, can reduce the pattern noise while maintaining snow traction compared to Examples 9 and 12.

### Example C

Tires (Examples 1 and 13 to 20) having the basic structure shown in FIG. 1 were prototyped based on the details shown in Table 3. The tires have the groove widths W1, W2, W3 and W4 of the outside shoulder circumferential groove, the outside crown circumferential groove, the inside crown circumferential groove and the inside shoulder circumferential groove, respectively, satisfying the following relation:

W1<W2<W3<W4.

The test results are shown in Table 3. The common specifications are the same as in Example A, except for the specifications in Table 3.

TABLE 3

| | Ex. 13 | Ex. 14 | Ex. 1 | Ex. 15 | Ex. 16 | Ex. 17 | Ex. 18 | Ex. 19 | Ex. 20 |
|---|---|---|---|---|---|---|---|---|---|
| Land ratio of outside middle land portion/land | 70 | 80 | 100 | 120 | 130 | 100 | 100 | 100 | 100 |
| ratio of inside middle land portion (%) | | | | | | | | | |
| Land ratio of outside shoulder land portion/ | 110 | 110 | 110 | 110 | 110 | 90 | 100 | 150 | 160 |
| land ratio of inside shoulder land portion (%) | | | | | | | | | |
| Pattern noise performance (index) | 122 | 128 | 130 | 131 | 134 | 121 | 127 | 132 | 134 |
| Snow traction performance (index) | 112 | 118 | 120 | 118 | 114 | 113 | 118 | 117 | 114 |
| Total evaluation (index) | 234 | 246 | 250 | 249 | 248 | 234 | 245 | 249 | 248 |

As a result of the test, it is confirmed that Examples 1, 14 and 15, in which the ratio of the land ratio of the outside middle land portion to the land ratio of the inside middle land portion falls within the preferable range, can reduce the pattern noise while maintaining snow traction compared to Examples 13 and 16. It is also confirmed that Examples 1, 18 and 19, in which the ratio of the land ratio of the outside shoulder land portion to the land ratio of the inside shoulder land portion falls within the preferable range, can reduce the pattern noise while maintaining snow traction compared to Examples 17 and 20.

The following clauses are disclosed regarding the above-described embodiments.

### [Clause 1]

A tire comprising:
a tread portion having a designated mounting direction to a vehicle, the tread portion comprising an outside tread edge located outwardly of a vehicle when being mounted to the vehicle, an inside tread edge located inwardly of a vehicle when being mounted to the vehicle, a plurality of circumferential grooves extending continuously in a tire circumferential direction between the outside tread edge and the inside tread edge, and a plurality of lateral grooves extending in a direction intersecting the plurality of circumferential grooves, wherein
the plurality of circumferential grooves comprises an outside shoulder circumferential groove, an outside crown circumferential groove, an inside crown circumferential groove and an inside shoulder circumferential groove which are arranged in this order from an outside tread edge side to an inside tread edge side, and
a groove width W1 of the outside shoulder circumferential groove, a groove width W2 of the outside crown circumferential groove, a groove width W3 of the inside crown circumferential groove and a groove width W4 of the inside shoulder circumferential groove satisfy the following relation:

W1<W2<W3<W4.

### [Clause 2]

The tire according to clause 1, wherein
the tread portion comprises an inside middle land portion defined between the inside shoulder circumferential groove and the inside crown circumferential groove, and
the plurality of lateral grooves comprises a plurality of inside middle lateral grooves extending from the inside shoulder circumferential groove to the inside crown circumferential groove.

### [Clause 3]

The tire according to clause 2, wherein
the tread portion comprises a crown land portion defined between the outside crown circumferential groove and the inside crown circumferential groove, and
the plurality of lateral grooves comprises a plurality of crown lateral grooves extending from the inside crown circumferential groove and terminating within the crown land portion.

### [Clause 4]

The tire according to clause 3, wherein
the plurality of crown lateral grooves comprises first openings that opens to the inside crown circumferential groove,
the plurality of inside middle lateral grooves comprises second opening that open to the inside crown circumferential groove, and
the respective first openings are arranged in different locations in the tire circumferential direction from the respective second openings so as not to face the respective second openings in a tire axial direction.

### [Clause 5]

The tire according to clause 3 or 4, wherein
a sum of a total value of maximum groove widths of the plurality of crown lateral grooves and a total value of maximum groove widths of the inside middle lateral grooves is in a range of 30% to 40% of a circumferential length of the tread portion.

### [Clause 6]

The tire according to any one of clauses 2 to 5, wherein
the tread portion comprises an inside shoulder land portion defined between the inside shoulder circumferential groove and the inside tread edge, and
the plurality of lateral grooves comprises a plurality of inside shoulder lateral grooves extending from the inside shoulder circumferential groove to the inside tread edge.

### [Clause 7]

The tire according to clause 6, wherein
the plurality of inside middle lateral grooves comprises third openings that open to the inside shoulder circumferential groove,
the plurality of inside shoulder lateral grooves comprises fourth openings that open to the inside shoulder circumferential groove, and
the respective third openings are arranged in different locations in the tire circumferential direction from the respective fourth openings so as not to face the respective fourth openings in a tire axial direction.

### [Clause 8]

The tire according to clause 6 or 7, wherein
a sum of a total value of maximum groove widths of the plurality of inside shoulder lateral grooves and a total value of maximum groove widths of the inside middle lateral grooves is in a range of 20% to 30% of a circumferential length of the tread portion.

### [Clause 9]

The tire according to any one of clauses 1 to 8, wherein
the tread portion comprises an outside middle land portion defined between the outside shoulder circumferential groove and the outside crown circumferential groove, and
the plurality of lateral grooves comprises a plurality of the first outside middle lateral grooves extending from the outside shoulder circumferential groove and terminating within the outside middle land portion.

### [Clause 10]

The tire according to clause 9, wherein
the plurality of lateral grooves comprises a plurality of second outside middle lateral grooves extending from the outside crown circumferential groove and terminating within the outside middle land portion.

### [Clause 11]

The tire according to clause 10, wherein
the plurality of first outside middle lateral grooves comprises fifth openings that open to the outside shoulder circumferential groove,
the second outside middle lateral grooves comprises sixth openings that open to the outside crown circumferential groove, and
the respective fifth openings are arranged in different locations in the tire circumferential direction from the respective sixth openings.

### [Clause 12]

The tire according to any one of clauses 1 to 11, wherein
the tread portion comprises an outside middle land portion defined between the outside shoulder circumferential groove and the outside crown circumferential groove, and an inside middle land portion defined between the inside shoulder circumferential groove and the inside crown circumferential groove, and
a land ratio of the outside middle land portion is in a range of 80% to 120% of a land ratio of the inside middle land portion.

### [Clause 13]

The tire according to any one of clauses 1 to 12, wherein
the tread portion comprises an outside shoulder land portion defined between the outside shoulder circumferential groove and the outside tread edge, and an inside shoulder land portion defined between the inside shoulder circumferential groove and the inside tread edge, and
a land ratio of the outside shoulder land portion is in a range of 100% to 150% of a land ratio of the inside shoulder land portion.

1. A tire comprising:
a tread portion having a designated mounting direction to a vehicle, the tread portion comprising an outside tread edge located outwardly of a vehicle when being mounted to the vehicle, an inside tread edge located inwardly of a vehicle when being mounted to the vehicle, a plurality of circumferential grooves extending continuously in a tire circumferential direction between the outside tread edge and the inside tread edge, and a plurality of lateral grooves extending in a direction intersecting the plurality of circumferential grooves, wherein
the plurality of circumferential grooves comprises an outside shoulder circumferential groove, an outside crown circumferential groove, an inside crown circumferential groove and an inside shoulder circumferential groove which are arranged in this order from an outside tread edge side to an inside tread edge side, and
a groove width W1 of the outside shoulder circumferential groove, a groove width W2 of the outside crown circumferential groove, a groove width W3 of the inside crown circumferential groove and a groove width W4 of the inside shoulder circumferential groove satisfy the following relation:
W1<W2<W3<W4.

2. The tire according to claim 1, wherein
the tread portion comprises an inside middle land portion defined between the inside shoulder circumferential groove and the inside crown circumferential groove, and
the plurality of lateral grooves comprises a plurality of inside middle lateral grooves extending from the inside shoulder circumferential groove to the inside crown circumferential groove.

3. The tire according to claim 2, wherein
the tread portion comprises a crown land portion defined between the outside crown circumferential groove and the inside crown circumferential groove, and
the plurality of lateral grooves comprises a plurality of crown lateral grooves extending from the inside crown circumferential groove and terminating within the crown land portion.

4. The tire according to claim 3, wherein
the plurality of crown lateral grooves comprises first openings that opens to the inside crown circumferential groove,
the plurality of inside middle lateral grooves comprises second opening that open to the inside crown circumferential groove, and
the respective first openings are arranged in different locations in the tire circumferential direction from the respective second openings so as not to face the respective second openings in a tire axial direction.

5. The tire according to claim 3, wherein
a sum of a total value of maximum groove widths of the plurality of crown lateral grooves and a total value of maximum groove widths of the inside middle lateral grooves is in a range of 30% to 40% of a circumferential length of the tread portion.

6. The tire according to claim 2, wherein
the tread portion comprises an inside shoulder land portion defined between the inside shoulder circumferential groove and the inside tread edge, and
the plurality of lateral grooves comprises a plurality of inside shoulder lateral grooves extending from the inside shoulder circumferential groove to the inside tread edge.

7. The tire according to claim 6, wherein
the plurality of inside middle lateral grooves comprises third openings that open to the inside shoulder circumferential groove,
the plurality of inside shoulder lateral grooves comprises fourth openings that open to the inside shoulder circumferential groove, and
the respective third openings are arranged in different locations in the tire circumferential direction from the respective fourth openings so as not to face the respective fourth openings in a tire axial direction.

8. The tire according to claim 6, wherein
a sum of a total value of maximum groove widths of the plurality of inside shoulder lateral grooves and a total value of maximum groove widths of the inside middle lateral grooves is in a range of 20% to 30% of a circumferential length of the tread portion.

9. The tire according to claim 1, wherein
the tread portion comprises an outside middle land portion defined between the outside shoulder circumferential groove and the outside crown circumferential groove, and
the plurality of lateral grooves comprises a plurality of the first outside middle lateral grooves extending from the outside shoulder circumferential groove and terminating within the outside middle land portion.

10. The tire according to claim 9, wherein
the plurality of lateral grooves comprises a plurality of second outside middle lateral grooves extending from the outside crown circumferential groove and terminating within the outside middle land portion.

11. The tire according to claim 10, wherein
the plurality of first outside middle lateral grooves comprises fifth openings that open to the outside shoulder circumferential groove,
the second outside middle lateral grooves comprises sixth openings that open to the outside crown circumferential groove, and
the respective fifth openings are arranged in different locations in the tire circumferential direction from the respective sixth openings.

12. The tire according to claim 1, wherein
the tread portion comprises an outside middle land portion defined between the outside shoulder circumferential groove and the outside crown circumferential groove, and an inside middle land portion defined between the inside shoulder circumferential groove and the inside crown circumferential groove, and
a land ratio of the outside middle land portion is in a range of 80% to 120% of a land ratio of the inside middle land portion.

13. The tire according to claim 1, wherein
the tread portion comprises an outside shoulder land portion defined between the outside shoulder circumferential groove and the outside tread edge, and an inside shoulder land portion defined between the inside shoulder circumferential groove and the inside tread edge, and
a land ratio of the outside shoulder land portion is in a range of 100% to 150% of a land ratio of the inside shoulder land portion.

14. The tire according to claim 4, wherein
a minimum distance L1 in the tire circumferential direction between circumferentially adjacent one of the first openings and one of the second openings is in a range of from 3% to 7% of a tread width.

15. The tire according to claim 7, wherein
a minimum distance L2 in the tire circumferential direction between circumferentially adjacent one of the third openings and one of the fourth openings is in a range of from 4% to 8% of a tread width TW.

16. The tire according to claim 4, wherein
the tread portion comprises an inside shoulder land portion defined between the inside shoulder circumferential groove and the inside tread edge,
the plurality of lateral grooves comprises a plurality of inside shoulder lateral grooves extending from the inside shoulder circumferential groove to the inside tread edge,
the plurality of inside middle lateral grooves comprises third openings that open to the inside shoulder circumferential groove,
the plurality of inside shoulder lateral grooves comprises fourth openings that open to the inside shoulder circumferential groove, and
the respective third openings are arranged in different locations in the tire circumferential direction from the respective fourth openings so as not to face the respective fourth openings in a tire axial direction.

17. The tire according to claim 16, wherein
a maximum groove width of the crown lateral grooves is greater than a maximum groove width of the inside middle lateral grooves.

18. The tire according to claim 16, wherein
a maximum groove width of the crown lateral grooves is greater than a maximum groove width of the inside shoulder lateral grooves.

19. The tire according to claim 17, wherein
the maximum groove width of the crown lateral grooves is greater than a maximum groove width of the inside shoulder lateral grooves.

20. The tire according to claim 16, wherein
the tread portion comprises an outside middle land portion defined between the outside shoulder circumferential groove and the outside crown circumferential groove,
the plurality of lateral grooves comprises a plurality of the first outside middle lateral grooves extending from the outside shoulder circumferential groove and terminating within the outside middle land portion,
the plurality of lateral grooves comprises a plurality of second outside middle lateral grooves extending from the outside crown circumferential groove and terminating within the outside middle land portion,
the plurality of first outside middle lateral grooves comprises fifth openings that open to the outside shoulder circumferential groove,
the second outside middle lateral grooves comprises sixth openings that open to the outside crown circumferential groove, and
the respective fifth openings are arranged in different locations in the tire circumferential direction from the respective sixth openings.
